(19) United States
(12) Patent Application Publication
(10) Pub. No.: US 2024/0322861 A1
(43) Pub. Date: Sep. 26, 2024

(54) NEAR FIELD COMMUNICATION FOR PAIRING WEARABLE DEVICES

(71) Applicant: Snap Inc., Santa Monica, CA (US)

(72) Inventors: Dawei Zhang, Seattle, WA (US); Katie Lu, Santa Monica, CA (US)

(21) Appl. No.: 18/124,114

(22) Filed: Mar. 21, 2023

(51) Int. Cl. H04B 5/00; H04W 4/80; H04W 76/10

(52) U.S. Cl. CPC H04B 5/72; H04W 4/80; H04W 76/10

(57) ABSTRACT

A system includes a user device having a near field communication (NFC) interface. The system also includes a short-range wireless communication interface configured to communicate with devices in a local physical space. The system also includes one or more processors and a non-transitory computer readable storage medium storing instructions for detecting, via the NFC interface, near field proximity between the user device and a NFC-enabled device, receiving pairing information from the NFC-enabled device via the NFC interface, processing the pairing information to establish communication between the system and a wireless-enabled device located in the local physical space via the short-range wireless communication interface, receiving location information from the wireless-enabled device via the short-range wireless communication interface, and determining a location of the user device in the local physical space, relative to at least one reference point, using the location information.

### BACKGROUND

The use of personal mobile devices to facilitate localized, in-person interactions and transactions is increasingly common. Purchases, exchange of information, and sharing of real-time content or experiences can all be facilitated by mobile devices such as smartphones. However, the ease of performing such transactions is often hampered by the need to authorize or authenticate the transaction, or to establish a connection to the counterparty using account information stored on remote servers on a network.

The increased adoption of wearable devices, such as augmented reality (AR) glasses, exacerbates these problems. Wearable devices often rely on gesture or voice command input, which can present usability, privacy, and/or security problems in gathering user input required to authorize or authenticate transactions. These problems are particularly acute in public settings.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation to facilitate discussion of a networked environment in which the present disclosure may be deployed, according to some examples.

FIG. 2 is a diagrammatic representation to facilitate discussion of a messaging system, according to some examples, that has both client-side and server-side functionality.

FIG. 3 illustrates a system including a head-wearable apparatus, to facilitate discussion of some examples.

FIG. 4 is a diagrammatic representation to facilitate discussion of a machine in the form of a computer system within which a set of instructions may be executed to cause the machine to perform any one or more of the methodologies discussed herein, according to some examples.

FIG. 5 is a block diagram showing a software architecture to facilitate discussion of some examples.

FIG. 6 illustrates a simplified schematic diagram to facilitate discussion of a user system and a kiosk performing a NFC pairing interaction, according to some examples.

FIG. 7 illustrates a simplified schematic diagram to facilitate discussion of the user system of FIG. 6 in paired communication with wireless-enabled devices in the same local physical space.

FIG. 8 illustrates a simplified schematic diagram to facilitate discussion of a user system and a second user system performing a NFC pairing interaction as an alternative to the NFC pairing interaction of FIG. 7.

FIG. 9 is a flow chart to facilitate discussion of a method 900 for using NFC to pair devices and coordinate the presentation of augmented reality content, according to some examples.

### DETAILED DESCRIPTION

Near Field Communication (NFC) technology can be used as a component in an attempt to address one or more of the technical problems identified above. NFC uses inductive coupling between corresponding antennas of two devices to establish a very short-range (e.g., less than 10 cm) wireless communication link, which can be used to exchange information as long as the two devices are in near field proximity (e.g., within NFC range). Because NFC links can typically only be established intentionally by the users of both devices, they can serve as a useful modality for establishing the intent of both users to perform a casual transaction that does not pose a significant security or privacy risk.

One such low-risk casual transaction is the pairing of two devices for further communication over a short-range wireless communication interface, such as a Bluetooth® interface. Ordinarily, pairing two devices for Bluetooth® communication involves a number of steps requiring user input and authorization by the users of both devices being paired. However, once paired, the paired devices can use the Bluetooth® link to directly exchange further information without the need to route the information exchange through user accounts managed by a remote server accessed by both devices via a network. This type of short-range link is thus particularly appropriate for exchanging non-sensitive data that does not compromise the user's privacy or security when exchanged with other non-trusted devices present in a shared local physical space: for example, location information specifying the user's exact physical location within the local physical space.

Furthermore, Bluetooth® provides a further means to facilitate the generation and exchange of precise location data for paired devices sharing a local physical space: the Bluetooth® Low Energy (BLE) protocol allows Bluetooth®-enabled devices to act as beacons, whereby another Bluetooth®-enabled device can use the signal strength of the beacon to determine the beacon's physical distance with a high degree of accuracy. Thus, multiple Bluetooth®-enabled device can accurately determine their locations relative to each other using BLE-based triangulation. The availability of accurate location data for multiple devices can be important for the accurate presentation of shared augmented reality (AR) content.

Some wearable devices, such as AR glasses, naturally lend themselves to sharing real-time experiences with the users of other devices present in a shared local physical space. However, it may be unduly cumbersome to individually establish a connection to the user account of each other participant present in the shared local physical space. By using an NFC interaction (also called a “tap” or “NFC tap” herein) to exchange pairing information for two or more Bluetooth®-enabled devices, the devices can be paired for ongoing Bluetooth® and/or BLE communication, which can include the exchange of location information for ongoing tracking of the relative locations of the various devices within a shared local physical space. This interaction avoids the need for any user to provide authentication or authorization credentials using gesture or voice command inputs in the shared public space, thereby mitigating privacy and security risks. The interaction also avoids the need for any user to perform the often cumbersome process of identifying the user account of another user present within the space and establishing, via a remote network server, an ongoing authorization of the other user's account (e.g., a “friend” relationship) to share content or otherwise communicate with the user's device.

### Networked Computing Environment

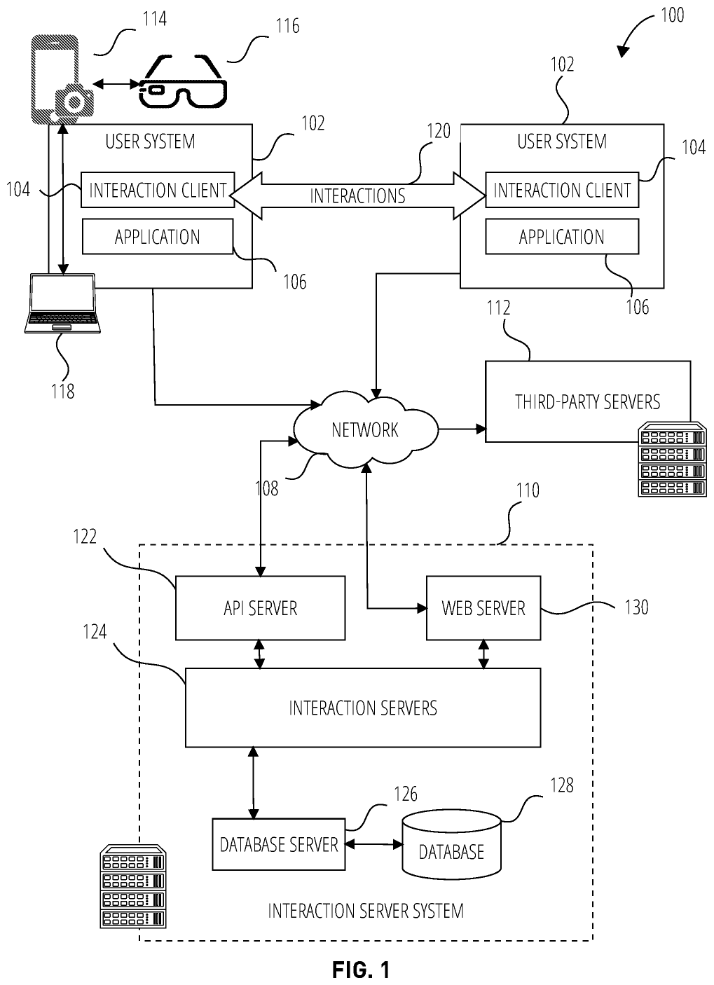

FIG. 1 is a block diagram showing an example interaction system 100 for facilitating interactions (e.g., exchanging text messages, conducting text audio and video calls, or playing games) over a network. The interaction system 100 includes multiple client systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the client systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104).

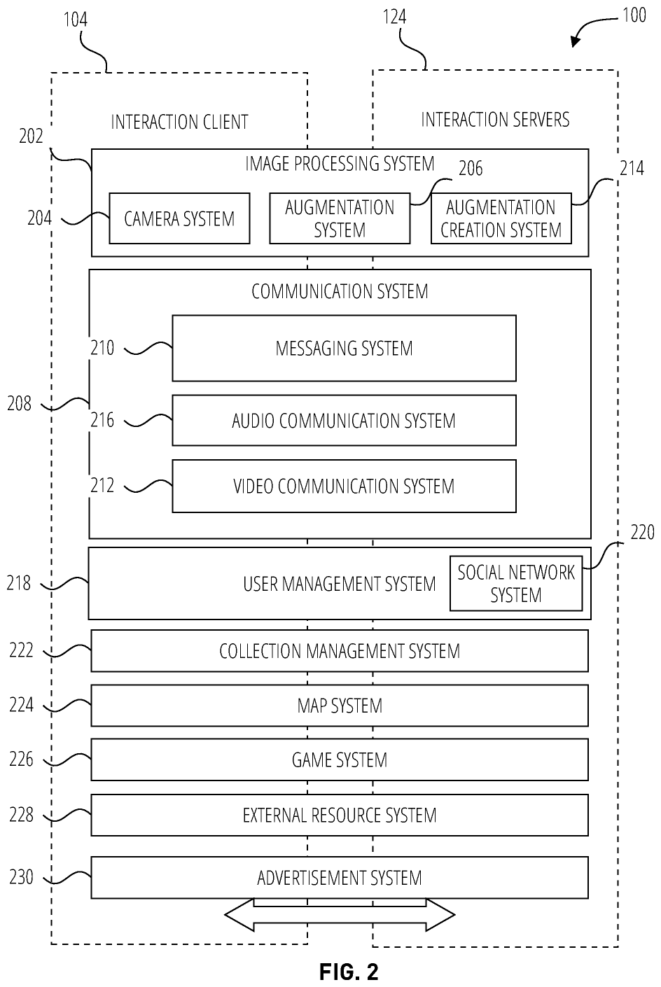

The interaction servers 124 host multiple systems and subsystems, described below with reference to FIG. 2.

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 302 of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enabling access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and includes a social network system 220 that maintains information regarding relationships between users of the interaction system 100.

A collection management system 222 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 222 may also be responsible for publishing an icon that provides notification of a particular collection to the user interface of the interaction client 104. The collection management system 222 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 222 employs machine vision (or image recognition technology) and content rules to curate a content collection automatically. In certain examples, compensation may be paid to a user to include user-generated content into a collection. In such cases, the collection management system 222 operates to automatically make payments to such users to use their content.

A map system 224 provides various geographic location functions and supports the presentation of map-based media content and messages by the interaction client 104. For example, the map system 224 enables the display of user icons or avatars on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

In some examples, the map system 224 implements some of the operations of the methods described herein. For example, the map system 224 may be configured to determine a location of one or more of the user devices of the user system 102. Data encoding such location information, referred to herein as user device location information, may be made available to other users (e.g., “friends” of the user of the user system 102, or other users paired with the user system 102 within a shared local physical space as described below). In some examples, the map system 224 may use location information generated by one or more BLE beacons, as described in greater details below, to improve the accuracy of the user device location information and/or to assist with the various functions of the map system 224 described above.

A game system 226 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 228 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A WebViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 230 operationally enables the purchasing of advertisements by third parties for presentation to end-users via the interaction clients 104 and also handles the delivery and presentation of these advertisements.

System with Head-Wearable Apparatus

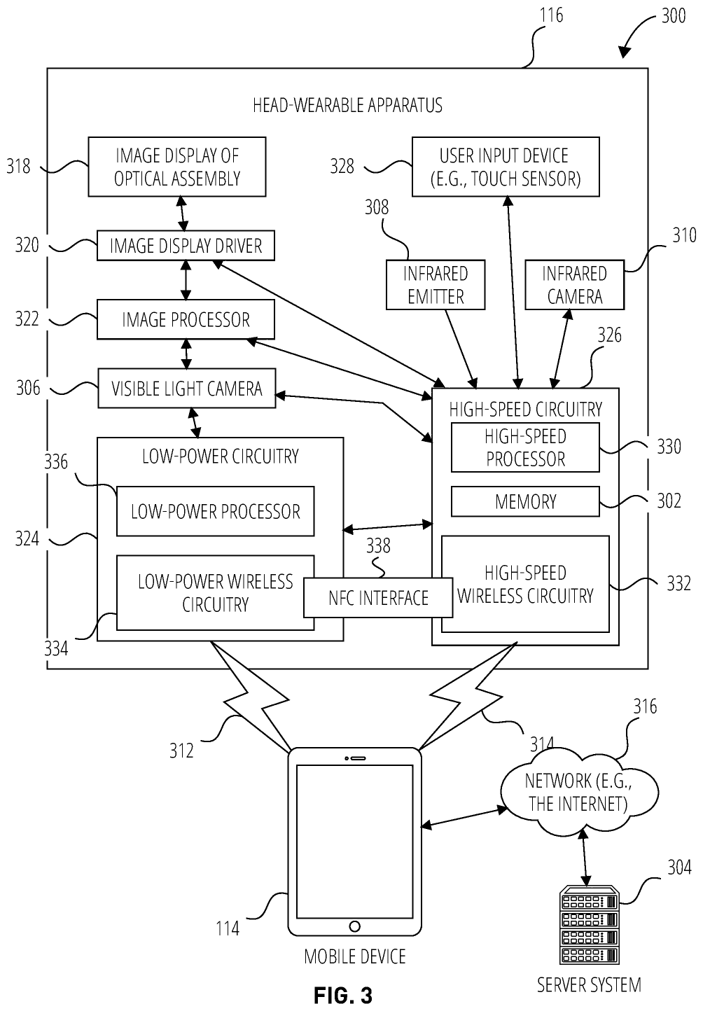

FIG. 3 illustrates a system 300 including a head-wearable apparatus 116 with a selector input device, according to some examples. FIG. 3 is a high-level functional block diagram of an example head-wearable apparatus 116 communicatively coupled to a mobile device 114 and various server systems 304 (e.g., the interaction server system 110) via various networks 108.

The head-wearable apparatus 116 includes one or more cameras, each of which may be, for example, a visible light camera 306, an infrared emitter 308, and an infrared camera 310.

The mobile device 114 connects with head-wearable apparatus 116 using both a low-power wireless connection 312 and a high-speed wireless connection 314. The mobile device 114 is also connected to the server system 304 and the network 316.

The head-wearable apparatus 116 further includes two image displays of the image display of optical assembly 318. The two image displays of optical assembly 318 include one associated with the left lateral side and one associated with the right lateral side of the head-wearable apparatus 116. The head-wearable apparatus 116 also includes an image display driver 320, an image processor 322, low-power circuitry 324, and high-speed circuitry 326. The image display of optical assembly 318 is for presenting images and videos, including an image that can include a graphical user interface to a user of the head-wearable apparatus 116.

The image display driver 320 commands and controls the image display of optical assembly 318. The image display driver 320 may deliver image data directly to the image display of optical assembly 318 for presentation or may convert the image data into a signal or data format suitable for delivery to the image display device. For example, the image data may be video data formatted according to compression formats, such as H.264 (MPEG-4 Part 10), HEVC, Theora, Dirac, Real Video RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 328 (e.g., touch sensor or push button), including an input surface on the head-wearable apparatus 116. The user input device 328 (e.g., touch sensor or push button) is to receive from the user an input selection to manipulate the graphical user interface of the presented image.

The components shown in FIG. 3 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 306 can include digital camera elements such as a complementary metal oxide semiconductor (CMOS) image sensor, charge-coupled device, camera lenses, or any other respective visible or light-capturing elements that may be used to capture data, including images of scenes with unknown objects.

The head-wearable apparatus 116 includes a memory 302, which stores instructions to perform a subset or all of the functions described herein. The memory 302 can also include one or more storage devices.

As shown in FIG. 3, the high-speed circuitry 326 includes a high-speed processor 330, a memory 302, and high-speed wireless circuitry 332. In some examples, the image display driver 320 is coupled to the high-speed circuitry 326 and operated by the high-speed processor 330 in order to drive the left and right image displays of the image display of optical assembly 318. The high-speed processor 330 may be any processor capable of managing high-speed communications and operation of any general computing system needed for the head-wearable apparatus 116. The high-speed processor 330 includes processing resources needed for managing high-speed data transfers on a high-speed wireless connection 314 to a wireless local area network (WLAN) using the high-speed wireless circuitry 332. In certain examples, the high-speed processor 330 executes an operating system such as a LINUX operating system or other such operating system of the head-wearable apparatus 116, and the operating system is stored in the memory 302 for execution. In addition to any other responsibilities, the high-speed processor 330 executing a software architecture for the head-wearable apparatus 116 is used to manage data transfers with high-speed wireless circuitry 332. In certain examples, the high-speed wireless circuitry 332 is configured to implement Institute of Electrical and Electronic Engineers (IEEE) 802.11 communication standards, also referred to herein as WiFi. In some examples, other high-speed communications standards may be implemented by the high-speed wireless circuitry 332.

The low-power wireless circuitry 334 and the high-speed wireless circuitry 332 of the head-wearable apparatus 116 can include short-range transceivers (e.g., Bluetooth®) and wireless wide, local, or wide area network transceivers (e.g., cellular or WiFi). Mobile device 114, including the transceivers communicating via the low-power wireless connection 312 and the high-speed wireless connection 314, may be implemented using details of the architecture of the head-wearable apparatus 116, as can other elements of the network 316.

A near field communication (NFC) interface 338 configured to perform near field communication is implemented by the low-power wireless circuitry 334 and/or the high-speed wireless circuitry 332. The NFC interface 338 uses inductive coupling between an antenna of the head-wearable apparatus 116 (which may be part of the low-power wireless circuitry 334 and/or the high-speed wireless circuitry 332) and the antenna of another NFC-enabled device to communicate in one or both directions. In some examples, the NFC communications use a frequency of 13.56 MHz in the globally available unlicensed radio frequency ISM band using the ISO/IEC 18000-3 air interface standard.

The memory 302 includes any storage device capable of storing various data and applications, including, among other things, camera data generated by the left and right visible light cameras 306, the infrared camera 310, and the image processor 322, as well as images generated for display by the image display driver 320 on the image displays of the image display of optical assembly 318. While the memory 302 is shown as integrated with high-speed circuitry 326, in some examples, the memory 302 may be an independent standalone element of the head-wearable apparatus 116. In certain such examples, electrical routing lines may provide a connection through a chip that includes the high-speed processor 330 from the image processor 322 or the low-power processor 336 to the memory 302. In some examples, the high-speed processor 330 may manage addressing of the memory 302 such that the low-power processor 336 will boot the high-speed processor 330 any time that a read or write operation involving memory 302 is needed.

As shown in FIG. 3, the low-power processor 336 or high-speed processor 330 of the head-wearable apparatus 116 can be coupled to the camera (visible light camera 306, infrared emitter 308, or infrared camera 310), the image display driver 320, the user input device 328 (e.g., touch sensor or push button), and the memory 302.

The head-wearable apparatus 116 is connected to a host computer. For example, the head-wearable apparatus 116 is paired with the mobile device 114 via the high-speed wireless connection 314 or connected to the server system 304 via the network 316. The server system 304 may be one or more computing devices as part of a service or network computing system, for example, that includes a processor, a memory, and network communication interface to communicate over the network 316 with the mobile device 114 and the head-wearable apparatus 116.

The mobile device 114 includes a processor and a network communication interface coupled to the processor. The network communication interface allows for communication over the network 316, low-power wireless connection 312, or high-speed wireless connection 314. Mobile device 114 can further store at least portions of the instructions for generating binaural audio content in the mobile device 114's memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 320. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 304, such as the user input device 328, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include biometric sensors, additional sensors, or display elements integrated with the head-wearable apparatus 116. For example, peripheral device elements may include any I/O components including output components, motion components, position components, or any other such elements described herein.

For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth® transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 312 and high-speed wireless connection 314 from the mobile device 114 via the low-power wireless circuitry 334 or high-speed wireless circuitry 332.

### Machine Architecture

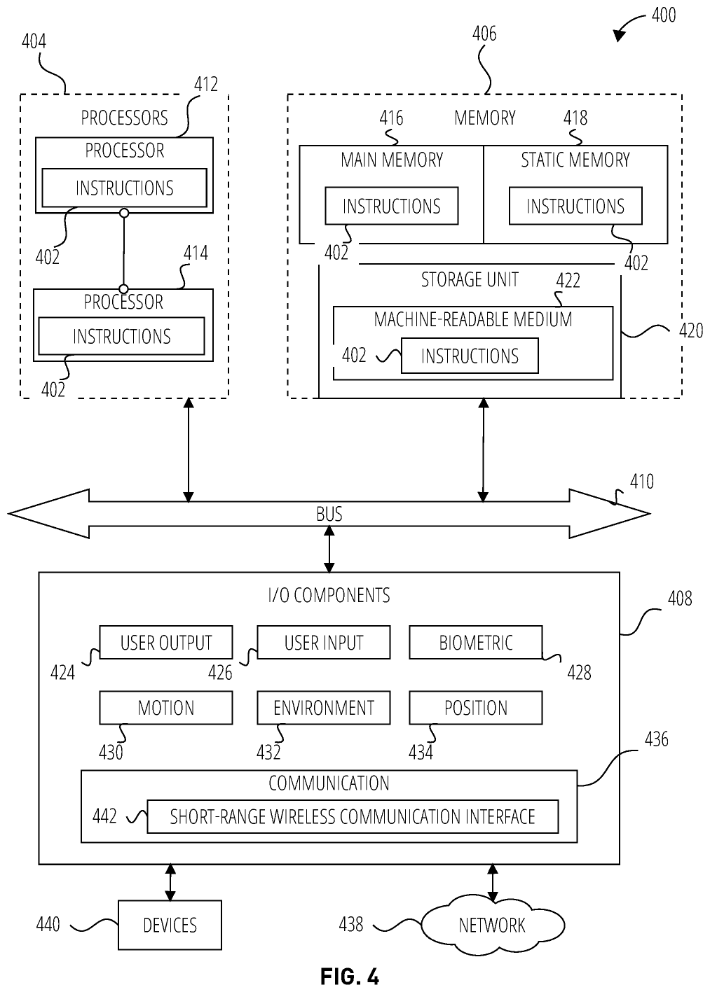

FIG. 4 is a diagrammatic representation of the machine 400 within which instructions 402 (e.g., software, a program, an application, an applet, an app, or other executable code) for causing the machine 400 to perform any one or more of the methodologies discussed herein may be executed. For example, the instructions 402 may cause the machine 400 to execute any one or more of the methods described herein. The instructions 402 transform the general, non-programmed machine 400 into a particular machine 400 programmed to carry out the described and illustrated functions in the manner described. The machine 400 may operate as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is illustrated, the term “machine” shall also be taken to include a collection of machines that individually or jointly execute the instructions 402 to perform any one or more of the methodologies discussed herein. The machine 400, for example, may comprise the user system 102 or any one of multiple server devices forming part of the interaction server system 110. In some examples, the machine 400 may also comprise both client and server systems, with certain operations of a particular method or algorithm being performed on the server-side and with certain operations of the particular method or algorithm being performed on the client-side.

The machine 400 may include processors 404, memory 406, and input/output I/O components 408, which may be configured to communicate with each other via a bus 410. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 412 and a processor 414 that execute the instructions 402. The term “processor” is intended to include multi-core processors that may comprise two or more independent processors (sometimes referred to as “cores”) that may execute instructions contemporaneously. Although FIG. 4 shows multiple processors 404, the machine 400 may include a single processor with a single-core, a single processor with multiple cores (e.g., a multi-core processor), multiple processors with a single core, multiple processors with multiples cores, or any combination thereof.

The memory 406 includes a main memory 416, a static memory 418, and a storage unit 420, both accessible to the processors 404 via the bus 410. The main memory 406, the static memory 418, and storage unit 420 store the instructions 402 embodying any one or more of the methodologies or functions described herein. The instructions 402 may also reside, completely or partially, within the main memory 416, within the static memory 418, within machine-readable medium 422 within the storage unit 420, within at least one of the processors 404 (e.g., within the processor's cache memory), or any suitable combination thereof, during execution thereof by the machine 400.

The I/O components 408 may include a wide variety of components to receive input, provide output, produce output, transmit information, exchange information, capture measurements, and so on. The specific I/O components 408 that are included in a particular machine will depend on the type of machine. For example, portable machines such as mobile phones may include a touch input device or other such input mechanisms, while a headless server machine will likely not include such a touch input device. It will be appreciated that the I/O components 408 may include many other components that are not shown in FIG. 4. In various examples, the I/O components 408 may include user output components 424 and user input components 426. The user output components 424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 408 may include biometric components 428, motion components 430, environmental components 432, or position components 434, among a wide array of other components. For example, the biometric components 428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 430 include acceleration sensor components (e.g., accelerometer), gravitation sensor components, rotation sensor components (e.g., gyroscope).

The environmental components 432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 434 include location sensor components (e.g., a GPS receiver component), altitude sensor components (e.g., altimeters or barometers that detect air pressure from which altitude may be derived), orientation sensor components (e.g., magnetometers), and the like. In some examples, the position components 434 use location information received via the short-range wireless communication interface to assist in determining a location of the machine 400. In some examples, the location information is received from one or more wireless-enabled devices, such as BLE beacon location information generated by one or more BLE beacons.

Communication may be implemented using a wide variety of technologies. The I/O components 408 further include communication components 436 operable to couple the machine 400 to a network 438 or devices 440 via respective coupling or connections. For example, the communication components 436 may include a network interface component or another suitable device to interface with the network 438. In further examples, the communication components 436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 440 may be another machine or any of a wide variety of peripheral devices (e.g., a peripheral device coupled via a USB). In some examples, the communication components 436 include at least a short-range wireless communication interface configured to communicate with one or more wireless-enabled devices in a shared local physical space via a short-range wireless communication protocol such as Wi-Fi® (e.g., an IEEE 802.11 wireless protocol) or Bluetooth®.

Moreover, the communication components 436 may detect identifiers or include components operable to detect identifiers. For example, the communication components 436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 436, such as location via Internet Protocol (IP) geolocation, location via Wi-Fi® signal triangulation, location via detecting an NFC beacon signal that may indicate a particular location, and so forth.

The various memories (e.g., main memory 416, static memory 418, and memory of the processors 404) and storage unit 420 may store one or more sets of instructions and data structures (e.g., software) embodying or used by any one or more of the methodologies or functions described herein. These instructions (e.g., the instructions 402), when executed by processors 404, cause various operations to implement the disclosed examples.

The instructions 402 may be transmitted or received over the network 438, using a transmission medium, via a network interface device (e.g., a network interface component included in the communication components 436) and using any one of several well-known transfer protocols (e.g., hypertext transfer protocol (HTTP)). Similarly, the instructions 402 may be transmitted or received using a transmission medium via a coupling (e.g., a peer-to-peer coupling) to the devices 440.

### Software Architecture

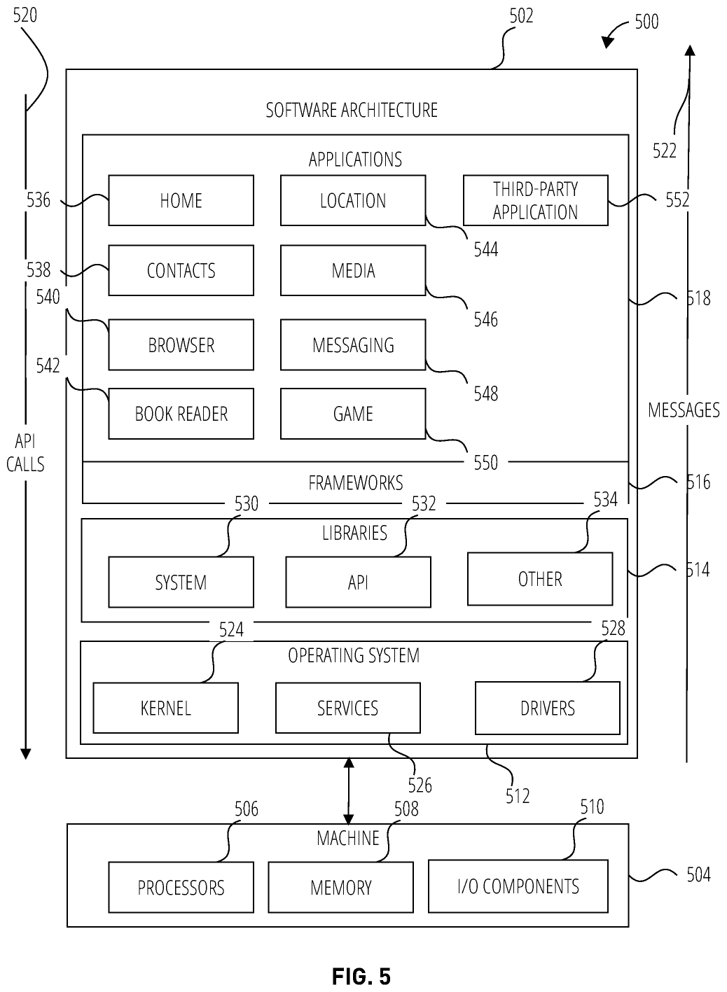

FIG. 5 is a block diagram 500 illustrating a software architecture 502, which can be installed on any one or more of the devices described herein. The software architecture 502 is supported by hardware such as a machine 504 that includes processors 506, memory 508, and I/O components 510. In this example, the software architecture 502 can be conceptualized as a stack of layers, where each layer provides a particular functionality. The software architecture 502 includes layers such as an operating system 512, libraries 514, frameworks 516, and applications 518. Operationally, the applications 518 invoke API calls 520 through the software stack and receive messages 522 in response to the API calls 520.

The operating system 512 manages hardware resources and provides common services. The operating system 512 includes, for example, a kernel 524, services 526, and drivers 528. The kernel 524 acts as an abstraction layer between the hardware and the other software layers. For example, the kernel 524 provides memory management, processor management (e.g., scheduling), component management, networking, and security settings, among other functionalities. The services 526 can provide other common services for the other software layers. The drivers 528 are responsible for controlling or interfacing with the underlying hardware. For instance, the drivers 528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 514 provide a common low-level infrastructure used by the applications 518. The libraries 514 can include system libraries 530 (e.g., C standard library) that provide functions such as memory allocation functions, string manipulation functions, mathematic functions, and the like. In addition, the libraries 514 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 514 can also include a wide variety of other libraries 534 to provide many other APIs to the applications 518.

The frameworks 516 provide a common high-level infrastructure that is used by the applications 518. For example, the frameworks 516 provide various graphical user interface (GUI) functions, high-level resource management, and high-level location services. The frameworks 516 can provide a broad spectrum of other APIs that can be used by the applications 518, some of which may be specific to a particular operating system or platform.

In an example, the applications 518 may include a home application 536, a contacts application 538, a browser application 540, a book reader application 542, a location application 544, a media application 546, a messaging application 548, a game application 550, and a broad assortment of other applications such as a third-party application 552. The applications 518 are programs that execute functions defined in the programs. Various programming languages can be employed to create one or more of the applications 518, structured in a variety of manners, such as object-oriented programming languages (e.g., Objective-C, Java, or C++) or procedural programming languages (e.g., C or assembly language). In a specific example, the third-party application 552 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 552 can invoke the API calls 520 provided by the operating system 512 to facilitate functionalities described herein.

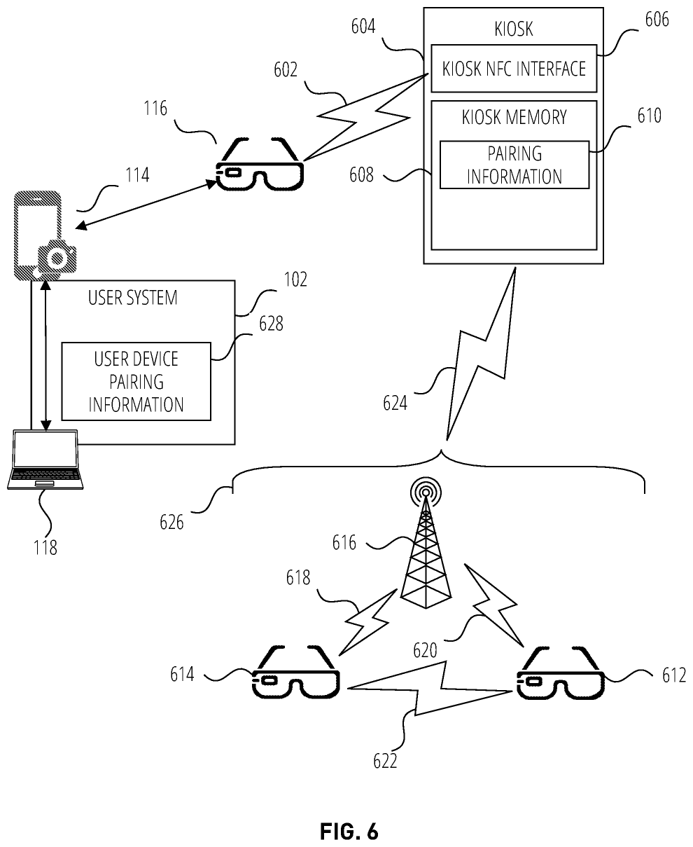

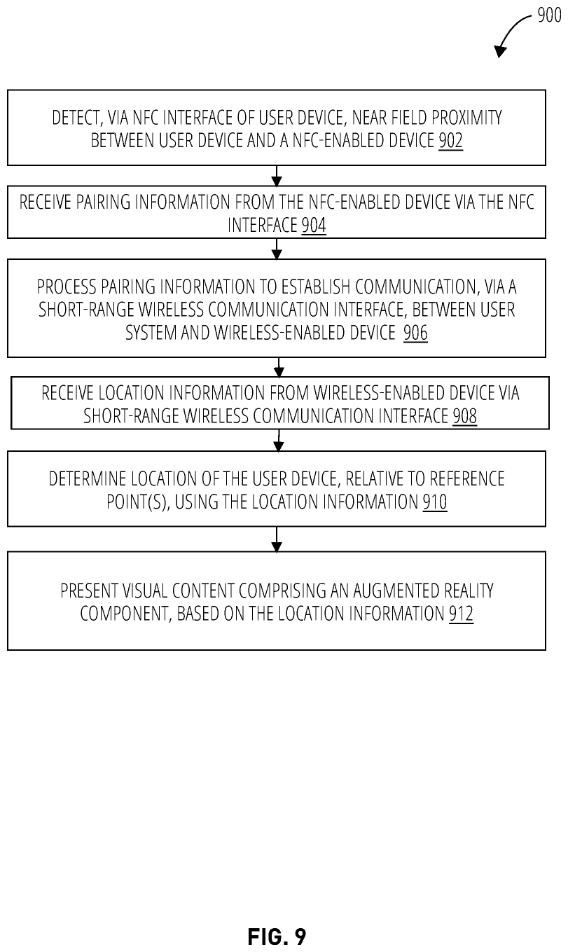

FIG. 6 shows a user system 102 and a kiosk 604 performing a NFC pairing interaction. Details of the pairing operation are described below with reference to method 900 shown in FIG. 9.

The example user system 102 includes one or more user devices. As illustrated, the user system 102 includes a mobile device 114, head-wearable apparatus 116, and computer client device 118, but in some examples one or more of these user devices can be omitted. In some examples, the user system 102 includes only the head-wearable apparatus 116. The user system 102 stores, in the memory of one or more of the user devices, user device pairing information 628, as further described below with reference to FIG. 9.

A kiosk 604 is shown as an example of a NFC-enabled device. The kiosk 604 includes a kiosk NFC interface 606 and a kiosk memory 608. Stored in the kiosk memory 608 is pairing information 610, as further described below with reference to FIG. 9. The kiosk 604 may be implemented as a machine 400 as described above. In some examples, the kiosk 604 is a wireless-enabled device such as a BLE beacon 616.

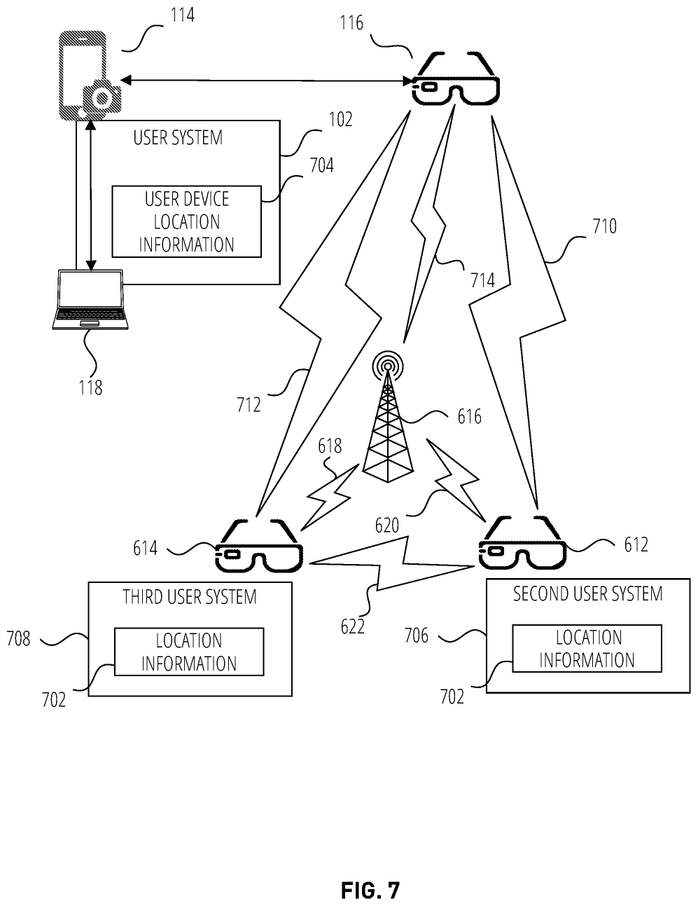

The pairing information 610 and user device pairing information 628 can be used to pair one or more user devices of the user system 102 with one or more wireless-enabled devices located in the same local physical space as the user system 102. In FIG. 7, the wireless-enabled devices are shown as a second head-wearable apparatus 612, a third head-wearable apparatus 614, and a BLE beacon 616. The wireless-enabled devices 626 are shown as being paired with each other to enable short-range wireless communication via reciprocal wireless links 618, 620, 622.

During the NFC interaction, the head-wearable apparatus 116 is brought into close proximity to the kiosk NFC interface 606. When the head-wearable apparatus 116 is within near field proximity of the kiosk NFC interface 606 (e.g., within a few centimeters or the range of the particular NFC technology being used), an NFC link 602 is established between the NFC interface 338 of the head-wearable apparatus 116 and the kiosk NFC interface 606. Data can be exchanged via the NFC link 602, such as the pairing information 610 and the user device pairing information 628. The user system 102 receives the pairing information 610 and uses the pairing information 610 to perform its portion of a pairing operation. The kiosk 604 transmits the user device pairing information 628, via a wireless link 624, to one or more of the wireless-enabled devices 626, which perform their own respective portions of the pairing operation. After all portions of the pairing operation are performed, one or more user devices of the user system 102 are configured to communicate directly, via the short-range wireless communication interface 442, with one or more of the wireless-enabled devices 626, as described below with reference to FIG. 7.

FIG. 7 shows the user system 102 of FIG. 6 in paired communication with the wireless-enabled devices 626 of FIG. 6 sharing the same local physical space.

After the user device (e.g., head-wearable apparatus 116) of the user system 102 is paired with one or more of the wireless-enabled devices 626, two-way short-range wireless communication between the devices is possible via the short-range wireless communication interface 442 by establishing reciprocal wireless links for such communication. These links are shown as a link 710 between the head-wearable apparatus 116 and the second head-wearable apparatus 612, a link 712 between the head-wearable apparatus 116 and the third head-wearable apparatus 614, and a link 714 between the head-wearable apparatus 116 and the BLE beacon 616.

The head-wearable apparatus 116 can then use the links 710, 712, 714 to receive location information 702 from the second head-wearable apparatus 612 and third head-wearable apparatus 614, and can receive BLE beacon location information from the BLE beacon 616 (e.g., distance information derived from the signal strength of the BLE beacon 616). The head-wearable apparatus 116 can also transmit user device location information 704 to the one or more wireless-enabled devices 626. In various examples, the location information 702 and/or user device location information 704 include one or more types of information processable to determine a location of the user device and/or the wireless-enabled device in the local physical space, relative to at least one reference point. The location information 702 and/or user device location information 704 can include a signal having a strength that can be sensed to determine a distance (e.g., a BLE beacon signal, a Wi-Fi™ signal, and/or an ultra wide band (UWB) signal). In some examples, one or more of the head-wearable apparatus 116, second head-wearable apparatus 612, and/or third head-wearable apparatus 614 also operates as a BLE beacon to generate a BLE beacon signal measurable by other devices in wireless communication therewith. The location information 702 and/or user device location information 704 can include one or more types of location data generated or collected by position components 434 of the user device and/or the wireless-enabled device. Further details of the generation, exchange, and processing of location information 702 and user device location information 704 are described below with reference to FIG. 9.

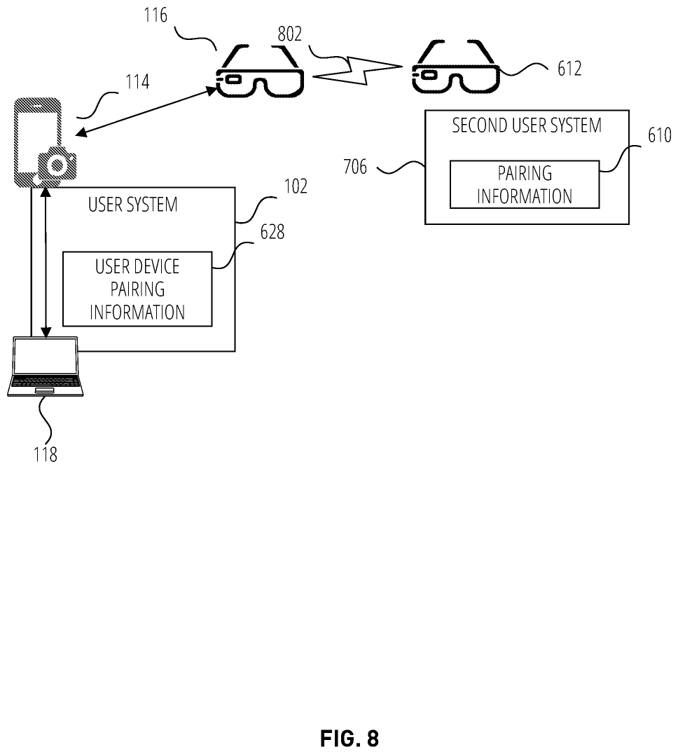

FIG. 8 shows an alternative to the NFC pairing interaction of FIG. 6. In FIG. 8, the head-wearable apparatus 116 performs the NFC pairing interaction with the second head-wearable apparatus 612. The NFC link 802 is established between the NFC interface 338 of the head-wearable apparatus 116 and a corresponding NFC interface 338 of the second head-wearable apparatus 612 when the two head-wearable apparatus are brought into near field proximity, as in the NFC interaction of FIG. 6. The NFC link 802 is then used to exchange the pairing information 610 and user device pairing information 628. In some examples, as escribed in greater details below with reference to FIG. 9, the pairing information 610 enables the head-wearable apparatus 116 to pair with more than one wireless-enabled device, e.g., it enables pairing with not only the second head-wearable apparatus 612 but also one or more of the other wireless-enabled devices 626.

FIG. 9 shows an example method 900 for using NFC to pair devices and coordinate the presentation of augmented reality content. As described above, NFC can be used as a convenient and usable modality for pairing devices. The paired devices can then provide accurate relative location information to each other, which can facilitate the accurate presentation of AR content to the users of one or both devices.

Method 900 is described as being performed by one or more user devices of a system, such as user system 102. In particular, the NFC operations of method 900 are described as being performed by the head-wearable apparatus 116, whereas the operations using the short-range wireless communication interface 442 are described as being performed by the head-wearable apparatus 116 or another user device of the user system 102, such as a mobile device 114. In particular, the operations of method 900 are described with reference to the simplified schematic diagrams of FIG. 6 through FIG. 8, showing the head-wearable apparatus 116 being used to perform the NFC operations to pair a short-range wireless communication interface 442 of the user system 102 with one or more wireless-enabled devices 626 present in the same local physical space as the user system 102. However, it will be appreciated that in some examples the method 900 can be performed using any suitable device or combination of devices configured to perform NFC communication and short-range wireless communication.

In operation 902, a user device of a user system 102 (e.g., head-wearable apparatus 116) detects, via a near field communication (NFC) interface 338 of the user device, near field proximity between the user device and a NFC-enabled device. As shown in FIG. 6, the head-wearable apparatus 116 is tapped or otherwise brought into near field proximity to the kiosk NFC interface 606. The NFC interface 338 of the head-wearable apparatus 116 detects the near field proximity of the kiosk NFC interface 606. Alternatively, as shown in FIG. 8, the head-wearable apparatus 116 is tapped or otherwise brought into near field proximity to the NFC interface of the second head-wearable apparatus 612, and the NFC interface 338 of the head-wearable apparatus 116 detects the near field proximity of the second head-wearable apparatus 612. Thus, in various examples the NFC-enabled device may be the kiosk 604, the second head-wearable apparatus 612, or another device having an NFC interface.

In operation 904, the user device receives pairing information 610 from the NFC-enabled device via the NFC interface 338. The pairing information 610 includes information enabling pairing of the head-wearable apparatus 116 to at least one of the wireless-enabled devices 626, which can include one or more BLE beacons 616, one or more head-wearable apparatus, a wireless-enabled kiosk 604, and/or other wireless-enabled devices. In some examples, operation 904 also includes the transmission of the user device pairing information 628 to the NFC-enabled device, to be used by the one or more wireless-enabled devices to complete a pairing operation.

In operation 906, the user system 102 processes the pairing information 610 to establish communication, via a short-range wireless communication interface 442 of the user system 102, between the user system 102 and one or more of the wireless-enabled devices 626 located in a local physical space shared by the user system 102. In some examples, the short-range wireless communication interface 442 is a Bluetooth® interface, and the pairing information 610 includes information necessary for the head-wearable apparatus 116 to pair with a corresponding Bluetooth® interface of one or more wireless-enabled devices. In some examples, the short-range wireless communication interface 442 is a Wi-Fi™ interface, and the pairing information 610 includes information necessary for the head-wearable apparatus 116 to pair with a corresponding Wi-Fi™ interface of one or more wireless-enabled devices: for example, the pairing information 610 may contain Wi-Fi™ SSID and login information necessary to implement communication and/or signal strength detection with respect to one or more wireless-enabled devices acting as Wi-Fi™ access points. In some examples, instead of Bluetooth® or Wi-Fi™, another short-range wireless communication technology may be used in the pairing operation 906.

As described above, in various examples the wireless-enabled device being paired with the user device at operation 906 may be the same device or a different device from the NFC-enabled device of operations 902 and 904. In examples in which the NFC-enabled device is separate from the wireless-enabled device, the user device pairing information 628 may be relayed to the one or more wireless-enabled devices 626 by the NFC-enabled device (e.g., the kiosk 604 of FIG. 6 or the second head-wearable apparatus 612 of FIG. 8). For example, the NFC-enabled device may be in communication with the one or more wireless-enabled devices 626 via a short-range wireless communication interface or another communication interface, and may transmit the user device pairing information 628 to the wireless-enabled devices 626 via this communication interface. The corresponding portion of the pairing operation, performed by the wireless-enabled device or a system in communication therewith, may be performed as part of (or concurrently with) operation 906 to complete the pairing of the user device (e.g., head-wearable apparatus 116) with the wireless-enabled device. For example, the second user system 706 in communication with the second head-wearable apparatus 612 may process the user device pairing information 628 to pair the second head-wearable apparatus 612 (or another user device of the second user system 706) with the head-wearable apparatus 116. Similarly, the third user system 708 in communication with the third head-wearable apparatus 614 may process the user device pairing information 628 to pair the third head-wearable apparatus 614 (or another user device of the third user system 708) with the head-wearable apparatus 116.

In some examples, the pairing operation 906 is performed in response to further action by a user confirming or authorizing the pairing. For example, the user of the head-wearable apparatus 116 may be prompted (e.g., via the image display of optical assembly 318) to provide gesture or voice command input (or other user input) confirming the pairing operation. In some examples, the NFC tap at operation 902 may need to be accompanied by a specific physical manipulation of the user device and/or the NFC-enabled device to authorize the exchange of pairing information (at operation 904) and/or the pairing operation 906: for example, a button or other input component of the head-wearable apparatus 116 may need to be physically activated during the NFC tap, or the head-wearable apparatus 116 may need to be twisted or otherwise moved during the NFC tap, to authorize operations 904 and/or 906. In some examples, operations 904 and/or 906 may only be performed based on a pre-set configuration of the head-wearable apparatus 116, e.g., only if the NFC-enabled device is identified as a trusted device.

After operation 906, the user device (e.g., head-wearable apparatus 116), and therefore the user system 102, is configured to communicate with one or more wireless-enabled devices 626 via the short-range wireless communication interface 442. Thus, any user device of the user system 102 may communicate with any one of the wireless-enabled devices 626 with which at least one user device of the user system 102 ha been paired. This communication may be used to perform casual transactions or interactions that do not compromise the privacy or security of the user of the user system 102, such as shared augmented reality experiences. The communication may also be used to securely exchange credentials to authorize or authenticate more sensitive transactions, such as financial transactions. In some examples, the paired communication between the user device and a wireless-enabled device may be used to enable a longer-term, network-mediated relationship or transaction. For example, the user of the user system 102 may receive, via the short-range wireless communication interface 442, a user account identifier from a user of the wireless-enabled device (e.g., the user of the second head-wearable apparatus 612). This user account identifier may be processed by the user system 102, optionally conditional upon confirmatory input from the user, to establish a network-mediated connection to the identified user account (e.g., to create a “friend” relationship between the user account of the user of the user system 102 and the user account of the user of the second head-wearable apparatus 612). In some examples, biometric data is stored in a memory of the user system 102 for the user of that system. The biometric data is used as part of the communication with the paired device to authenticate the user as part of a secure or sensitive transaction.

In some examples, one of the casual transactions enabled by the pairing of the user device with the wireless-enabled device is the exchange of location information to allow one or both of the paired devices to accurately determine their physical locations relative to each other, or to one or more other reference points, within the shared local physical space. Two users of devices present in the same local physical space can typically see each other or otherwise determine each other's locations; thus, the exchange of location information between the two paired devices will not typically present a privacy or security risk. The shared location information can enable a number of useful applications, such as shared AR experiences or other interactions that rely on accurate spatial location information for a device. Not only can paired devices exchange location information generated by their respective position components 434, but the accuracy limitations of position components 434 such as GPS systems, especially in indoor or crowded environments, can potentially be overcome by pairing devices to locate each other using wireless beacon signals (e.g., BLE or Wi-Fi™ beacon signals).

In operation 908, the user device (e.g., head-wearable apparatus 116) receives location information 702 from the wireless-enabled device via the short-range wireless communication interface 442. In some examples, the location information 702 is a wireless signal, such as a BLE beacon signal or a Wi-Fi™ signal, which can be analyzed by the user device (e.g., by determining its signal strength) to determine a distance and/or direction of the wireless-enabled device, and which may be combined with location information 702 from one or more other wireless-enabled devices 626 to triangulate the location of the user device relative to the multiple wireless-enabled devices 626. In some examples, the location information 702 is information stored at the wireless-enabled device, such as data from the position components 434 of the wireless-enabled device stored in a memory of the wireless-enabled device. In some examples, the location information 702 includes data indicative of the locations of multiple devices; for example, a fixed BLE beacon 616 might include a memory storing location information 702 for multiple other wireless-enabled devices 626, and this location information 702 can be transmitted from the BLE beacon 616 to the user device to enable the user device to accurately locate itself relative to the multiple wireless-enabled devices 626, either alone on in combination with data from the position components 434 of the user device (or another user device of the user system 102).

In operation 910, the user system 102 determines a location of the user device in the local physical space, relative to at least one reference point, using the location information 702. As noted above, the location information 702 can take multiple forms, including wireless signals, information generated by the position components 434 of the wireless-enabled devices 626, and so on. The location information 702 can also be combined with other information, such as information generated by the user device or user system 102, to determine the user device location in operation 910. For example, the head-wearable apparatus 116 or another user device of the user system 102 may generate user device location information 704 (e.g., using the position components 434 of the head-wearable apparatus 116). This user device location information 704 can be combined with the location information 702 received regarding the various wireless-enabled devices 626 to determine the location of the head-wearable apparatus 116 relative to one or more reference points. The user device location information 704 can also be transmitted, in some examples, to the one or more wireless-enabled devices 626 via the short-range wireless communication interface 442.

In some examples, the location of the head-wearable apparatus 116 is determined relative to a reference point that is a fixed location in the local physical space. For example, a BLE beacon 616 may be located in a known, fixed location, and the signal strength of the BLE beacon 616 may be used as location information 702 to permit the head-wearable apparatus 116 to determine its own distance from the fixed BLE beacon 616. Location information 702 from another fixed BLE beacon 616, or another wireless-enabled device, or position data generated by the position components 434 of the head-wearable apparatus 116, can be processed to further determine a direction of the head-wearable apparatus 116 from the first fixed BLE beacon 616 and/or the location of the head-wearable apparatus 116 relative to the other wireless-enabled devices 626. Determining the location of the head-wearable apparatus 116 relative to the fixed BLE beacon 616, in combination with location information 702 indicating the location of one or more wireless-enabled devices relative to the fixed BLE beacon 616, allows the head-wearable apparatus 116 to determine its own location relative to those other wireless-enabled devices.

In some examples, the location of the head-wearable apparatus 116 is determined relative to one or more other mobile devices, such as the second head-wearable apparatus 612 following the NFC tap interaction shown in FIG. 8. In some such examples, one or both of the head-wearable apparatus may also have access to location information 702 enabling the determination of the two head-wearable apparatus relative to a fixed location. In some examples, one or both of the head-wearable apparatus may generate location information 702 from its position components 434 that can be used to roughly situate one of the head-wearable apparatus absolutely in the shared local physical space, thereby allowing both head-wearable apparatus to determine their own absolute locations. In some examples, only the relative locations of the two head-wearable apparatus are determined, and their absolute locations are not used by the techniques described herein.

In some examples, at the time of the NFC tap operations 902, 904, a known location of the NFC-enabled device (e.g., the kiosk 604) can be used to normalize the known location of the user device engaged in the NFC tap interaction. Because NFC tap interactions require near field proximity, the location of the user device is known to within a few centimeters at the moment of the NFC tap interaction. Thus, for example, the head-wearable apparatus 116 can record its location at the moment of the NFC tap interaction as being substantially identical to the location of the kiosk 604. Position components 434, such as an inertial measurement unit (IMU), can then be used to track movement of the head-wearable apparatus 116 away from the kiosk 604 to update the recorded location of the head-wearable apparatus 116. This tracking information may be used to determine the user device location information 704, which can be used by itself or in combination with other location information 702 to determine the locations of the head-wearable apparatus 116 and/or one or more wireless-enabled devices 626.

In operation 910, the user system 102 may also use comparable techniques to determine the locations of one or more other wireless-enabled devices 626 based on the location information 702 and/or the user device location information 704, relative to the one or more reference points. In some examples, each wireless-enabled device determines its own location and send this known location as further location information 702 to other devices, directly or indirectly, using short-range wireless communication. In some examples, a central location tracking system, such as the kiosk 604, a fixed BLE beacon 616, or a remote server accessible via a network, is used to receive location information 702 and or user device location information 704, determine the locations of the wireless-enabled devices 626, and propagate that information to the user device and/or the wireless-enabled devices 626.

In operation 912, the user system 102 presents visual content, including an augmented reality component, based on the location information 702. In some examples, the image display of optical assembly 318 of the head-wearable apparatus 116 displays visual content to a wearer of the head-wearable apparatus 116. The visual content includes at least one augmented reality component, which may be displayed in a specific spatial relationship to visible features of the wearer's environment (e.g., the local physical space) and/or to other wireless-enabled devices 626. For example, an augmented reality component may be displayed as a fixed or moving physical object that has a specific spatial relationship to a fixed reference point in the local physical space; the head-wearable apparatus 116 is configured to display the augmented reality component as the object would appear from the vantage point of the wearer of the head-wearable apparatus 116, based on the location of the head-wearable apparatus 116 as determined in operation 910. In another example, the augmented reality component may be displayed as an object or visual effect having a specific spatial relationship to another wearer of another head-wearable apparatus, such as second head-wearable apparatus 612; the head-wearable apparatus 116 is configured to display the object or visual effect in association with the wearer's view of the wearer of the second head-wearable apparatus 612 as it would appear from the vantage point of the wearer of the head-wearable apparatus 116, based on the location of the head-wearable apparatus 116 determined in operation 910, and based on the location of the second head-wearable apparatus 612.

The display of augmented reality content is enhanced by accurate location tracking. If an augmented reality component is intended to be displayed in association with a specific person (e.g., the wearer of the head-wearable apparatus 116 or the wearer of the second head-wearable apparatus 612), the location of the wearer's respective head-wearable apparatus should be known with a high degree of accuracy by each other device displaying the augmented reality component. Similarly, if an augmented reality component is intended to be interacted with by multiple viewers, each viewer should see the augmented reality component displayed with a high degree of accuracy at a location that is consistent with respect to the relative locations and orientations of the two viewers. Thus, for example, if the augmented reality component is a ball that can be thrown from one user to another based on user gestures, the display of the augmented reality component is enhanced if the location where each user sees the ball displayed is accurate relative to their respective locations, thereby mitigating any cognitive dissonance caused by mismatches between the behavior of the other user with respect to the augmented reality component and enhancing the perceived realism of the augmented reality component.

It will be appreciated that the augmented reality can include sensory content in non-visual modalities, such as audio content, which may also be enhanced by accurate spatial tracking.

In some examples, the pairing of the user device with the one or more wireless-enabled devices 626 may lapse or be deactivated when the user device leaves the local physical space. The pairing may be automatically re-established upon re-entering the local physical space in some examples, whereas in other examples the user device may need to re-pair by repeating the NFC tap operation 902, 904 in order to re-establish the pairing with the wireless-enabled devices 626.

### Conclusion

The inclusion of NFC capability in a user device, such as a head-wearable apparatus, can enable one or more techniques that attempt to address one or more technical problems. NFC interaction can be used to facilitate the pairing of two or more devices without the need for additional user input through gestures, voice commands, or other user input modalities. In the context of mobile devices, and in particular wearable devices such as head-wearable apparatus, this increases the usability of the pairing procedure.

Automatic, NFC-based pairing also avoids the need to identify the user accounts of other users in the shared local physical space and perform a multi-step process of creating a relationship between the user accounts associated with the two devices in order to initiate communication between the devices. This may further improve the usability of the process of establishing communications between devices present in the same local physical space, particularly when there are many such devices present and mutual communication is required with all of them. Furthermore, some interactions with devices in a shared local physical space may be most appropriately performed over a limited-purpose, temporary pairing between devices instead of a permanent relationship (e.g., a “friend” relationship) between the users of the devices. Thus, the temporary pairing enabled by NFC as described herein may avoid the need for “friend” relationships to be created and then later deleted after the required interactions are complete (e.g., after the user leaves the local physical space). Thus, techniques described herein can provide a location-contingent temporary relationship between two devices that expires automatically when one of the devices leaves the local physical space. Such temporary relationships may be particularly beneficial for enabling participation in temporary, location-specific shared experiences, in spaces such as museums, pop-up stores, etc.

By avoiding the need to authorize or authenticate the initiation of the connection between the devices using user account credentials, techniques described herein can also improve the security and privacy of the process of establishing a connection to another device. These problems may be particularly acute in a shared local physical space where multiple other people and their devices are present. Furthermore, as described above, after two devices are paired, the paired communication can be used to transmit user account credentials securely and privately should a transaction requiring such authentication or authorization arise.

By combining the NFC-based pairing interaction with paired short-range wireless communication, highly accurate location information can be generated and exchanged between the paired devices. Wireless signal strength and/or other forms of location information can be used to provide the various paired devices with highly accurate information regarding the relative locations of the various devices in the local physical space, enabling the accurate presentation of augmented reality content and/or other spatially-sensitive operations.

Some examples described herein allow a user to rely on a wearable device, such as a head-wearable apparatus, to serve as the sole point of contact for external interactions, even if the majority of the computational processing of the user system 102 is performed by one or more other user devices whereof, such as a mobile device 114. The wearable device can be used to perform the NFC tap interaction and automatically pair the head-wearable apparatus with the wireless-enabled devices 626, thereby enabling communication between the entire user system 102 and the wireless-enabled devices 626. Thus, a user device having significant computational resources can be stored on the user's body or in a bag without being readily accessible, because the head-wearable apparatus is used to perform all external interactions (e.g., the NFC tap) and all user input and output. This allows the user to interact and handle only a single user device, without needing to retrieve and manage a second device (e.g., mobile device 114) in performing external interactions.

Thus, various examples provide a user device, such as a head-wearable apparatus, including NFC capability for pairing with other devices.

Example 1 is a system comprising: a user device comprising a near field communication (NFC) interface; a short-range wireless communication interface configured to communicate with devices in a local physical space; one or more processors; and a non-transitory computer readable storage medium comprising instructions that, when executed by the one or more processors, cause the one or more processors to perform operations comprising: detecting, via the NFC interface, near field proximity between the user device and a NFC-enabled device; receiving pairing information from the NFC-enabled device via the NFC interface; processing the pairing information to establish communication between the system and a wireless-enabled device located in the local physical space via the short-range wireless communication interface; receiving location information from the wireless-enabled device via the short-range wireless communication interface; and determining a location of the user device in the local physical space, relative to at least one reference point, using the location information.

In Example 2, the subject matter of Example 1 includes, wherein: the at least one reference point comprises a location of the wireless-enabled device.

In Example 3, the subject matter of Examples 1-2 includes, wherein: the at least one reference point comprises a fixed location in the local physical space.

In Example 4, the subject matter of Examples 1-3 includes, wherein: the at least one reference point comprises one or more Bluetooth® Low Energy (BLE) beacons in the local physical space.

In Example 5, the subject matter of Example 4 includes, wherein: the one or more BLE beacons comprise the wireless-enabled device.

In Example 6, the subject matter of Examples 1-5 includes, wherein the operations further comprise: sending user device location information to the wireless-enabled device, the user device location information enabling a determination of a location of the short-range wireless communication interface by the wireless-enabled device.

In Example 7, the subject matter of Examples 1-6 includes, wherein: the short-range wireless communication interface comprises a Wi-Fi interface configured to communicate using an IEEE 802.11 wireless network protocol.

In Example 8, the subject matter of Examples 1-7 includes, wherein: the short-range wireless communication interface comprises a Bluetooth® interface.

In Example 9, the subject matter of Example 8 includes, wherein: the Bluetooth® interface is configured to communicate using a Bluetooth® Low Energy (BLE) protocol.

In Example 10, the subject matter of Example 9 includes, wherein: the Bluetooth® interface is configured to operate as a BLE beacon.

In Example 11, the subject matter of Examples 1-10 includes, wherein: the user device is a head-wearable apparatus, further comprising one or more image displays configured to display visual content to a user wearing the head-wearable apparatus; and the operations further comprise: presenting, on the one or more image displays, visual content comprising an augmented reality component, the presentation of the augmented reality component being based at least in part on the location information.

In Example 12, the subject matter of Example 11 includes, wherein: the head-wearable apparatus comprises the short-range wireless communication interface.

In Example 13, the subject matter of Examples 11-12 includes, wherein: the wireless-enabled device is a second head-wearable apparatus.

Example 14 is a method comprising: detecting, via a near field communication (NFC) interface of a user device of a user system, near field proximity between the user device and a NFC-enabled device; receiving, at the user device, pairing information from the NFC-enabled device via the NFC interface; processing the pairing information to establish communication, via a short-range wireless communication interface of the user system, between the user system and a wireless-enabled device located in a local physical space shared by the user system; receiving location information from the wireless-enabled device via the short-range wireless communication interface; and determining a location of the user device in the local physical space, relative to at least one reference point, using the location information.

In Example 15, the subject matter of Example 14 includes, wherein: the at least one reference point comprises a location of the wireless-enabled device.

In Example 16, the subject matter of Examples 14-15 includes, wherein: the at least one reference point comprises one or more Bluetooth® Low Energy (BLE) beacons in the local physical space.

In Example 17, the subject matter of Examples 14-16 includes, wherein: the short-range wireless communication interface comprises a Bluetooth® interface configured to communicate using a Bluetooth® Low Energy (BLE) protocol.

In Example 18, the subject matter of Examples 14-17 includes, wherein: the user device is a head-wearable apparatus, comprising one or more image displays configured to display visual content to a user wearing the head-wearable apparatus; and the method further comprises: presenting, on the one or more image displays, visual content comprising an augmented reality component, the presentation of the augmented reality component being based at least in part on the location information.

In Example 19, the subject matter of Examples 14-18 includes, wherein: the wireless-enabled device is a second head-wearable apparatus.

Example 20 is a non-transitory computer-readable storage medium, the computer-readable storage medium including instructions that when executed by a processor of a system, cause the system to: detect, via a near field communication (NFC) interface of a user device of the system, near field proximity between the user device and a NFC-enabled device; receive, at the user device, pairing information from the NFC-enabled device via the NFC interface; process the pairing information to establish communication, via a short-range wireless communication interface of the system, between the system and a wireless-enabled device located in a local physical space shared by the system; receive location information from the wireless-enabled device via the short-range wireless communication interface; and determine a location of the user device in the local physical space, relative to at least one reference point, using the location information.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20. Example 23 is a system to implement of any of Examples 1-20.

Example 24 is a method to implement of any of Examples 1-20.

Other technical features may be readily apparent to one skilled in the art from the following figures, descriptions, and claims.

### Glossary

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology. The term “network”, as used herein, shall refer to a communication network unless otherwise indicated.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A system comprising:
a user device comprising a near field communication (NFC) interface;
a short-range wireless communication interface configured to communicate with devices in a local physical space;
one or more processors; and
a non-transitory computer readable storage medium comprising instructions that, when executed by the one or more processors, cause the one or more processors to perform operations comprising:
detecting, via the NFC interface, near field proximity between the user device and a NFC-enabled device;
receiving pairing information from the NFC-enabled device via the NFC interface;
processing the pairing information to establish communication between the system and a wireless-enabled device located in the local physical space via the short-range wireless communication interface;
receiving location information from the wireless-enabled device via the short-range wireless communication interface; and
determining a location of the user device in the local physical space, relative to at least one reference point, using the location information.

2. The system of claim 1, wherein:
the at least one reference point comprises a location of the wireless-enabled device.

3. The system of claim 1, wherein:
the at least one reference point comprises a fixed location in the local physical space.

4. The system of claim 1, wherein:
the at least one reference point comprises one or more Bluetooth® Low Energy (BLE) beacons in the local physical space.

5. The system of claim 4, wherein:
the one or more BLE beacons comprise the wireless-enabled device.

6. The system of claim 1, wherein the operations further comprise:
sending user device location information to the wireless-enabled device, the user device location information enabling a determination of a location of the short-range wireless communication interface by the wireless-enabled device.

7. The system of claim 1, wherein:
the short-range wireless communication interface comprises a Wi-Fi interface configured to communicate using an IEEE 802.11 wireless network protocol.

8. The system of claim 1, wherein:
the short-range wireless communication interface comprises a Bluetooth® interface.

9. The system of claim 8, wherein:
the Bluetooth® interface is configured to communicate using a Bluetooth® Low Energy (BLE) protocol.

10. The system of claim 9, wherein:
the Bluetooth® interface is configured to operate as a BLE beacon.

11. The system of claim 1, wherein:
the user device is a head-wearable apparatus, further comprising one or more image displays configured to display visual content to a user wearing the head-wearable apparatus; and
the operations further comprise:
presenting, on the one or more image displays, visual content comprising an augmented reality component, the presentation of the augmented reality component being based at least in part on the location information.

12. The system of claim 11, wherein:
the head-wearable apparatus comprises the short-range wireless communication interface.

13. The system of claim 11, wherein:
the wireless-enabled device is a second head-wearable apparatus.

14. A method comprising:
detecting, via a near field communication (NFC) interface of a user device of a user system, near field proximity between the user device and a NFC-enabled device;
receiving, at the user device, pairing information from the NFC-enabled device via the NFC interface;
processing the pairing information to establish communication, via a short-range wireless communication interface of the user system, between the user system and a wireless-enabled device located in a local physical space shared by the user system;
receiving location information from the wireless-enabled device via the short-range wireless communication interface; and
determining a location of the user device in the local physical space, relative to at least one reference point, using the location information.

15. The method of claim 14, wherein:
the at least one reference point comprises a location of the wireless-enabled device.

16. The method of claim 14, wherein:
the at least one reference point comprises one or more Bluetooth® Low Energy (BLE) beacons in the local physical space.

17. The method of claim 14, wherein:
the short-range wireless communication interface comprises a Bluetooth® interface configured to communicate using a Bluetooth® Low Energy (BLE) protocol.

18. The method of claim 14, wherein:
the user device is a head-wearable apparatus, comprising one or more image displays configured to display visual content to a user wearing the head-wearable apparatus; and
the method further comprises:
presenting, on the one or more image displays, visual content comprising an augmented reality component, the presentation of the augmented reality component being based at least in part on the location information.

19. The method of claim 14, wherein:
the wireless-enabled device is a second head-wearable apparatus.

20. A non-transitory computer-readable storage medium, the computer-readable storage medium including instructions that when executed by a processor of a system, cause the system to:
detect, via a near field communication (NFC) interface of a user device of the system, near field proximity between the user device and a NFC-enabled device;
receive, at the user device, pairing information from the NFC-enabled device via the NFC interface;
process the pairing information to establish communication, via a short-range wireless communication interface of the system, between the system and a wireless-enabled device located in a local physical space shared by the system;
receive location information from the wireless-enabled device via the short-range wireless communication interface; and
determine a location of the user device in the local physical space, relative to at least one reference point, using the location information.
